(19) United States
(12) Patent Application Publication
(10) Pub. No.: US 2012/0079553 A1
(43) Pub. Date: Mar. 29, 2012

(54) Methods and Arrangements in a Telecommunication Network

(75) Inventor: Wei Wang, Saltsjo-Boo (SE)

(73) Assignee: TELEFONAKTIEBOLAGET L M ERICSSON (PUBL), Stockholm (SE)

(21) Appl. No.: 13/376,333

(22) PCT Filed: Jun. 11, 2009
(86) PCT No.: PCT/EP09/57235

§ 371 Date: Dec. 5, 2011

(51) Int. Cl. H04N 7/173

(52) U.S. Cl. 725/118

(57) ABSTRACT

The present invention relates to methods and arrangements for automatically providing presence status information regarding the line state in the IMS. This is achieved by a client based solution. The client (100) receives line state information from the voice/video module (220) of the user terminal and transfers the received line status information to the IMS module (230) of the user terminal. The IMS module (230) publishes the line status information to e.g. the PGM of the IMS (30) such that the line status information can be notified as presence information in the IMS.

### TECHNICAL FIELD

The present invention relates to methods and arrangements in a telecommunication network, and in particular to provision of presence information in an IMS network.

### BACKGROUND

The Internet Protocol (IP) Multimedia Subsystem (IMS) is an architecture for delivering IP multimedia services in telecommunication networks. The IMS 101 may be connected to fixed 102, 104 or wireless networks 103 as illustrated in FIG. 1 and controls IP based services provided by various content providers. Hence, IMS is the convergence of wireless and IP technology.

The user can connect to an IMS network in various ways, by using Session Initiating Protocol (SIP). IMS terminals such as mobile phones, personal digital assistants PDAs and laptops can register directly to an IMS network, even when they are roaming in another network or country. The only requirement is that they can use IP and run Session Initiation Protocol (SIP) user agents. As illustrated in FIG. 1, fixed access, mobile access (e.g. 3G, 4G systems) and wireless access (e.g. WLAN, WiMAX) are all supported. Other phone systems like plain old telephone service (POTS—the old analogue telephones), H.323 and non IMS-compatible VoIP systems, are supported through gateways.

Presence is a service which can be provided by the IMS. Presence allows a user to subscribe to presence information regarding other users, so that the user can see when other users are connected. By employing presence and messaging software the users are able to create “buddy lists” which indicate the current status of the people in the list. When a user is indicated as available, it is e.g. possible to use an Instant Messaging (IM) service to send and receive real-time messages. Thus, the presence information can be used to select the most appropriate time for starting a communication, as well as the most suitable communication tool. Examples of presence status information are “I am in a meeting”, “I am on-line”, “I am off-line”, “I am Busy”, “Do not disturb”, etc. Further information about what communication tools a user prefers may also be provide such as “Call me on my mobile”. In most situations, a communication is initiated from a contact list. An end user can create and manage a contact list by means of functionalities provided by the IMS, e.g. a Presence, Group and Data Management (PGM) node in the IMS. These lists are stored in the IMS network and can be reused by a user's different applications. The PGM node is a part of the IMS core residing in the application layer of the IMS network which provides presence, group, and data management capabilities to IMS applications.

It is desired to maintain the presence status information updated automatically. The IMS network is aware of services provided and/or controlled by the IMS such as IM (Instant Messaging), Chat, and Contact Management. When a user is participating in such an IMS controlled service, the IMS, e.g. a server in the IMS, can update its presence status accordingly. However, this situation is different for detection of voice and video line status which is needed to determine whether a user has established a voice or video call. It would be advantageous to be able to automatically indicate in the presence information whether a user is occupied by a call. However, for mobile devices, voice and video connections are controlled in a circuit switched (CS) network, which is not controlled by the IMS. Also in VoIP (Voice/Video over IP) which is handled by a separate application server (AS) on top of the IMS it is complicated to integrate the line status of a device with presence status in the IMS network. This depends on that each vendor has its own proprietary interface towards the CS and the VoIP nodes from where the line status information can be retrieved. Thus it is very difficult for a server in the IMS to retrieve line state information from the CS or the VoIP network which can be used for indicate the presence state.

### SUMMARY

Thus an object with the present invention is to at least provide an improved solution for automatically updating presence status information regarding the line state in the IMS.

This is achieved by a client based solution according to the embodiments of the present invention. The client receives line state information from the voice/video module of the user terminal and transfers the received line status information to the IMS module of the user terminal. The IMS module publishes the line status information to e.g. the PGM of the IMS such that the line status information can be notified as presence information in the IMS.

According to a first aspect of the present invention a client adapted for a user terminal is provided. The user terminal is configured for wireless communication with a mobile telecommunication network comprising an IMS. The client comprises a voice/video module adapted to manage connections to a voice/video switching network of the mobile telecommunication network and an IMS module adapted to manage IMS connections. The client comprises a control unit comprising a receiver for receiving line state information from the voice/video module, a transmitter for transmitting the received line state information to the IMS module. Furthermore, the IMS module comprises a transmitter for publishing the line state information to a node of the IMS (e.g. the PGM) such that the line state information can be notified as presence information in the IMS.

According to a second aspect of the present invention a control unit for a client of a user terminal is provided. The user terminal is configured for wireless communication with a mobile telecommunication network comprising an IMS. The user terminal client comprises a voice/video module adapted to manage connections to a voice/video switching network of the mobile telecommunication network and an IMS module adapted to manage IMS connections. The control unit comprises a receiver for receiving line state information from the voice/video module and a transmitter for transmitting the received line state information to the IMS module, such that the line state information can be published in the IMS to be notified as presence information.

According to a third aspect of the present invention a method in a client adapted for a user terminal is provided. The user terminal is configured for wireless communication with a mobile telecommunication network comprising an IMS. The client comprises a voice/video module adapted to manage connections to a voice/video switching network of the mobile telecommunication network and an IMS module adapted to manage IMS connections. In the method, line state information is received from the voice/video module and the received line state information (250) is transmitted to the IMS module. The line state information is published to a node of the IMS (300) from the IMS module such that the line state information (250) can be notified as presence information in the IMS.

According to a fourth aspect of the present invention a method in a control unit for a client of a user terminal is provided. The user terminal is configured for wireless communication with a mobile telecommunication network comprising an IMS. The user terminal client comprises a voice/video module adapted to manage connections to a voice/video switching network of the mobile telecommunication network and an IMS module adapted to manage IMS connections. In the method, line state information is received from the voice/video module and the received line state information is transmitted to the IMS module, such that the line state information can be published in the IMS which notifies the line state information to end-points, e.g. at other users' IMS user terminals.

An advantage with embodiments of the present invention is that the solution is independent of the voice/video control nodes, which makes it possible to deploy the solution in most CS and IMS networks. Today, there are no standard APIs (Application Programming Interfaces) to extract line status from voice/video control nodes and different vendors have their own definitions, which makes integration very costly if a server in the IMS network would extract the line status.

A further advantage with embodiments of the present invention is that no new network signaling is introduced. In prior art solutions, a proprietary signaling must be used when extracting line status from network nodes. However, in the client based solution, according to embodiments of the present invention, the line status is received directly from the terminal and communicated to the IMS via standard IMS signaling.

A yet further advantage is that only small development cost is required, since it is just a pure client implementation. In addition, there are no running costs, for e.g. OAM and Provisioning, since there are no needs to integrate the client based solution with any other network nodes.

### BRIEF DESCRIPTION OF THE DRAWINGS

FIG. 1 illustrates schematically an IMS network connected to different telecommunications networks according to prior art.

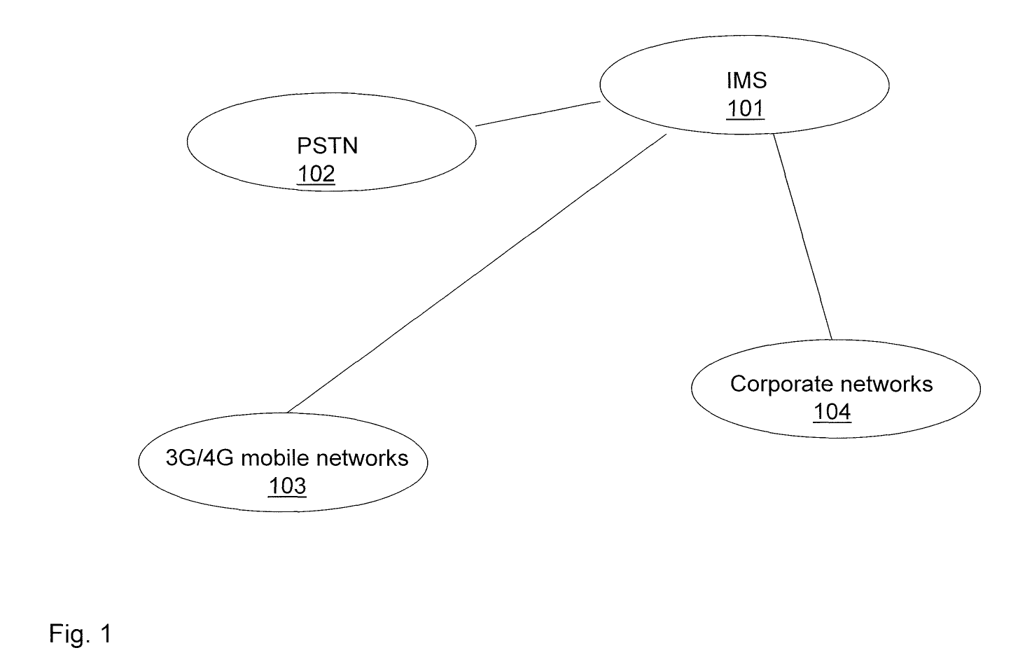

FIG. 2 illustrates schematically the arrangements of the embodiments of the present invention.

FIG. 3 is a sequence diagram of the method according to embodiments of the present invention.

FIG. 4 is a flowchart of the method in the control unit according to embodiments of the present invention.

### DETAILED DESCRIPTION

The present invention will be described more fully hereinafter with reference to the accompanying drawings, in which preferred embodiments of the invention are shown. The invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, like reference signs refer to like elements.

Moreover, those skilled in the art will appreciate that the means, units and functions explained herein below may be implemented using software functioning in conjunction with a programmed microprocessor or general purpose computer, and/or using an application specific integrated circuit (ASIC). It will also be appreciated that while the current invention is primarily described in the form of methods and devices, the invention may also be embodied in a computer program product as well as a system comprising a computer processor and a memory coupled to the processor, wherein the memory is encoded with one or more programs that may perform the functions disclosed herein.

As stated above, it is desired to maintain the presence status information updated automatically regarding voice and video line status such that a users in an IMS network can be notified automatically when another user has established a call.

This is achieved by a client based solution according to the embodiments of the present invention. A client is introduced in the user terminal and the client receives line state information from the voice/video module of the user terminal and transfers the received line status information to the IMS module of the user terminal. The IMS module publishes the line status information to e.g. the PGM of the IMS such that the line status information can be notified as presence information in the IMS. Hence, the basic idea is to utilize the possibility to detect line state information inside of a client of the user terminal. The detected line state information is published to a node in the IMS, referred to as the PGM node. PGM will further notify other end points in the network. In this way, the line status is a part of IMS Presence status and handled in the same way as any other presence state information inside the IMS framework.

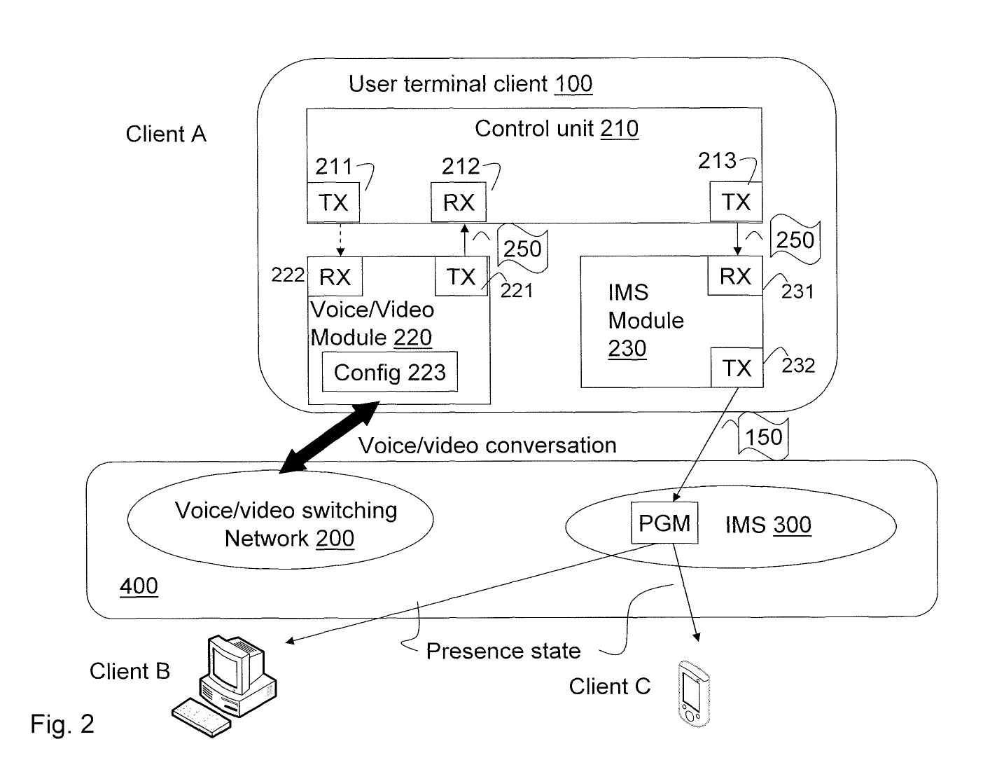

The client of embodiments of the present invention is illustrated in FIG. 2. A client 100 adapted to be implemented in a user terminal is provided. The user terminal is configured for wireless communication with a mobile telecommunication network 400 comprising an IMS 300. The IMS may comprise a PGM node for managing presence. The client 100 comprises a voice/video module 220 adapted to manage connections to a voice/video switching network 200 of the mobile telecommunication network 400 and an IMS module 230 adapted to manage IMS connections towards the IMS 300. In accordance with an embodiment of the present invention, the client 100 comprises a control unit 210 comprising a receiver 212 for receiving line state information 150 from the voice/video module 220 and a transmitter 213 for transmitting the received line state information 250 to the IMS module. The IMS module 230 comprises a transmitter 232 for publishing the line state information 250 to a node (e.g. the PGM) of the IMS 300. The line state information 250 can then be notified as presence information in the IMS to other clients, denoted client B and client C.

According to an embodiment of the present invention, the control unit 110 comprises a transmitter 111 for sending configurations 223 to a receiver 222 of the voice/video module 220. The configurations 223 control the voice/video module regarding when to send line state information. As an example, the configurations may comprise two different modes, and which mode to be used depends on which mode the application programming interface (API) of the voice/video module supports. One mode may imply that the control unit polls/requests line state information from the voice/video module in certain time intervals. In another mode, the control unit registers call-back in the voice/video module which implies that the voice/video module sends line state information when a voice or video call is established. I.e. the control unit 210 informs (i.e. registers) the voice/video module 220 that the voice/video module 220 should notify the control unit 210 whenever the line status is changed. Accordingly, a function, having a function identity, for handling the line status may be implemented by the control unit 210. This function is called/triggered by the voice/video module 220 whenever the line status is changed. During startup, the control unit 210 gives this function identity to the voice/video module 220. When the line status is changed, the voice/video module 220 will call/use this function identity. Then, it is up to the control unit 210 to handle the line status, i.e. to notify the IMS module.

Accordingly, the control unit 210 is adapted to configure the voice/video module 220 to transmit line state information upon a request and the control unit 210 further comprises a second transmitter (211) for requesting line state information 250 from the voice/video module 220. The receiver 212 of the control unit 210 is configured to receive the line state information 250 from the transmitter 221 of the voice/video module as a result of a request from the control unit.

Moreover, the control unit 210 is adapted to configure the voice/video module 220 to transmit line state information when a voice/video call is established. Hence, the transmitter 232 of the voice/video module 220 is configured to send line state information 250 when the voice/video call is established.

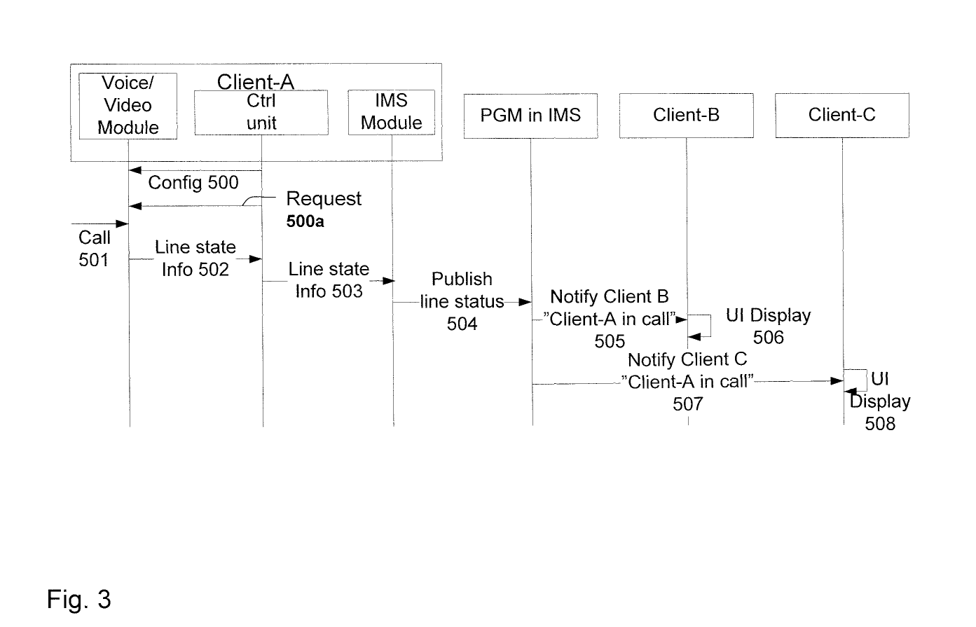

Turning now to FIG. 3 which is a sequence diagram of a method in the user terminal client according to an embodiment of the present invention.

In step 500, configurations, regarding when the line state information should be sent from the voice/video module, are sent from the control unit to the voice/video module. If a configuration should be used which implies that the control unit polls/requests line state information from the voice/video module in certain time intervals, the control unit sends 500a request to the voice/video module for line state information. In response to the request, the voice/video module sends 502 line state information to the control unit. Alternatively, when the configuration to be used implies that the voice/video module should send line state information when a call is established, the voice/video module sends 502 the line state information, when the call is established 501, to the control unit. I.e. Client_A makes a call or receives call from CS or VoIP network.

Further, the control unit transmits 503 the received line state information to the IMS module. The IMS module of the user terminal client publishes the line state information to a node of the IMS, e.g. a PGM node via SIP signalling. The line state information can now be notified 505, 507 as presence information to other end users Client_B, Client_C in the IMS. Each of the notified end users Client_B, Client_C displays 506, 508 the presence information that Client_A has a call established.

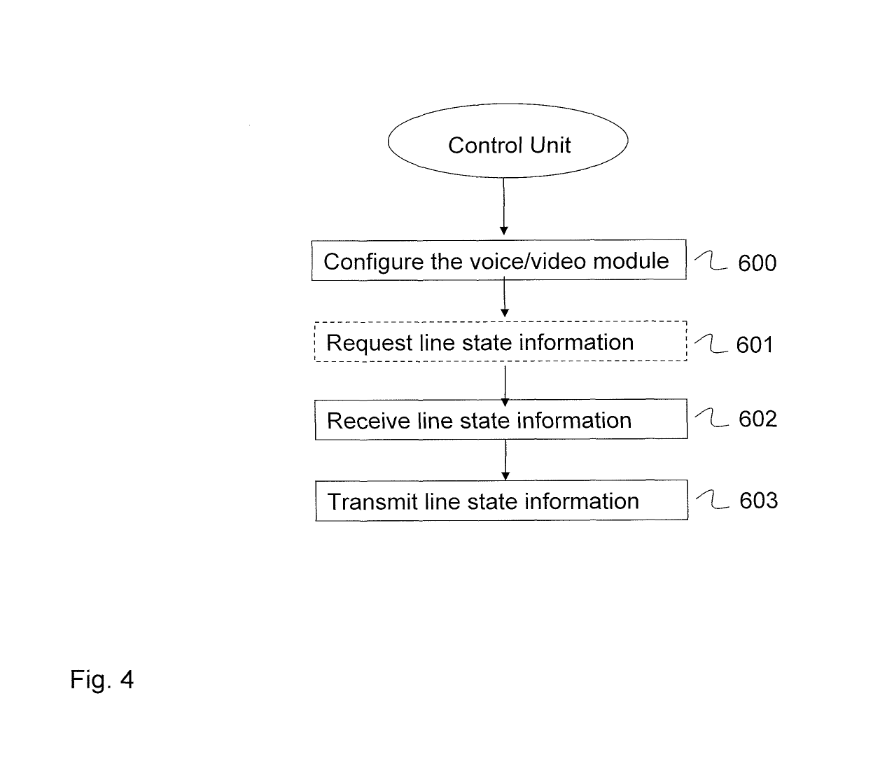

Furthermore, the embodiments of the present invention are also directed to the control unit of the user terminal client. As illustrated in the flowchart of FIG. 4, the control unit configures 601 the voice/video module when to transmit line state information. According to one embodiment, the line state information is requested 601 from the voice/video module. The line state information is received 602 and the control unit sends 603 the received line state information to the IMS module. In this way the line state information can be published in the IMS which notifies the line state information to end-points (end-users) of the IMS.

The present invention is not limited to the above-described preferred embodiments. Various alternatives, modifications and equivalents may be used. Therefore, the above embodiments should not be taken as limiting the scope of the invention, which is defined by the appending claims.

1-12. (canceled)

13. A user terminal client configured for wireless communication with a mobile telecommunication network that includes an Internet Protocol Multimedia Subsystem, IMS, wherein the client comprises:
a voice/video module configured to manage connections to a voice/video switching network of the mobile telecommunication network;
an IMS module configured to manage IMS connections; and
a control unit comprising a receiver configured to receive line state information from the voice/video module and a transmitter configured to transmit the received line state information to the IMS module;
wherein the IMS module comprises a transmitter configured to publish the line state information to a node of the IMS such that the line state information can be notified as presence information in the IMS.

14. The user terminal client according to claim 13, wherein the control unit is adapted to configure the voice/video module to transmit the line state information to the receiver of the control unit upon request, wherein the control unit further comprises a second transmitter configured to request the line state information from the voice/video module, and wherein the receiver of the control unit is configured to receive the line state information responsive to the second transmitter sending said request to the voice/video module.

15. The user terminal client according to claim 13, wherein the control unit is adapted to configure the voice/video module to transmit the line state information to the receiver of the control unit when a voice/video call is established and wherein the voice/video module includes a transmitter configured to send the line state information to the receiver of the control unit when the voice/video call is established.

16. A control unit for a user terminal client configured for wireless communication with a mobile telecommunication network that includes an Internet Protocol Multimedia Subsystem, IMS, wherein the control unit comprises:
a receiver configured to receive line state information from a voice/video module of the user terminal client that manages connections to a voice/video switching network of the mobile telecommunication network; and
a transmitter configured to transmit the received line state information to an IMS module of the user terminal client that manages IMS connections, such that the line state information can be published in the IMS to be notified as presence information.

17. The control unit according to claim 16, wherein the control unit is adapted to configure the voice/video module to transmit the line state information to the receiver upon request, wherein the control unit further comprises a second transmitter configured to request the line state information from the voice/video module, and wherein the receiver is configured to receive the line state information responsive to the second transmitter sending said request to the voice/video module.

18. The control unit according to claim 16, wherein the control unit is adapted to configure the voice/video module to transmit the line state information to the receiver when a voice/video call is established.

19. A method in a user terminal client configured for wireless communication with a mobile telecommunication network that includes an Internet Protocol Multimedia Subsystem, IMS, wherein the method comprises:
receiving line state information at a control unit of the user terminal client from a voice/video module of the user terminal client that manages connections to a voice/video switching network of the mobile telecommunication network;
transmitting the received line state information from the control unit to an IMS module of the user terminal client that manages IMS connections; and
from the IMS module, publishing the line state information to a node of the IMS such that the line state information can be notified as presence information in the IMS.

20. The method according to claim 19, wherein the method further comprises:
configuring, by the control unit, the voice/video module to transmit line state information upon request;
sending a request for line state information from the control unit to the voice/video module; and
receiving the line state information at the control unit responsive to the control unit sending said request to the voice/video module.

21. The method according to claim 19, wherein the method further comprises:
configuring, by the control unit, the voice/video module to transmit line state information when a voice/video call is established; and
sending line state information from the voice/video module when the voice/video call is established.

22. A method in a control unit for a user terminal client configured for wireless communication with a mobile telecommunication network that includes an Internet Protocol Multimedia Subsystem, IMS, wherein the method comprises:
receiving line state information at a control unit of the user terminal client from a voice/video module of the user terminal client that manages connections to a voice/video switching network of the mobile telecommunication network;
transmitting the received line state information from the control unit to an IMS module of the user terminal client that manages IMS connections, such that the line state information can be published in the IMS to be notified as presence information.

23. The method according to claim 22, wherein said receiving comprises:
configuring the voice/video module to transmit line state information upon request;
sending a request for line state information from the control unit to the voice/video module; and
receiving the line state information at the control unit responsive to the control unit sending said request to the voice/video module.

24. The method according to claim 22, further comprising configuring the voice/video module to transmit the line state information to the control unit when a voice/video call is established.
